(19) United States
(12) Patent Application Publication
(10) Pub. No.: US 2022/0356105 A1
(43) Pub. Date: Nov. 10, 2022

(54) GLASS FORMING DEVICES AND METHODS

(71) Applicant: CORNING INCORPORATED, CORNING, NY (US)

(72) Inventors: ILIA ANDREYEVICH NIKULIN, ITHACA, NY (US); ILYA SVYATOGOROV, Saint-Petersburg (RU); WILLIAM ANTHONY WHEDON, CORNING, NY (US)

(21) Appl. No.: 17/624,045

(22) PCT Filed: Jun. 18, 2020
(86) PCT No.: PCT/US2020/038340

§ 371 Date: Dec. 30, 2021

Related U.S. Application Data
(60) Provisional application No. 62/869,190, filed on Jul. 1, 2019.

(51) Int. Cl. C03B 17/06

(52) U.S. Cl. CPC C03B 17/064; C03B 17/067; C03B 17/068

(57) ABSTRACT

Glass forming devices can comprise a first outer surface of a first wall, a second outer surface of a second wall, and a heater. Glass forming methods can comprise flowing a first stream of molten material over a first outer surface of the first wall and flowing a second stream of molten material over a second outer surface of the second wall. Methods can further comprise drawing a glass ribbon. Methods can also comprise heating the first wall with the heater to heat an inner portion of the first stream of molten material contacting the first outer surface of the first wall to maintain a viscosity of the inner portion of the first stream of molten material below the liquidus viscosity of the first stream of molten material.

### CROSS-REFERENCE TO RELATED APPLICATION

This application claims the benefit of priority under 35 U.S.C. § 119 of U.S. Provisional Application Ser. No. 62/869190 filed on Jul. 1, 2019, the content of which is relied upon and incorporated herein by reference in its entirety.

### BACKGROUND

It is known to process molten material into a glass ribbon with a forming apparatus. Conventional forming apparatus are known to operate to down draw a quantity of molten material from the forming apparatus as the glass ribbon. Glass ribbons can be separated into glass sheets. Glass sheets are commonly used, for example, in display applications, for example, liquid crystal displays (LCDs), electrophoretic displays (EPD), organic light emitting diode displays (OLEDs), plasma display panels (PDPs), touch sensors, photovoltaics, or the like.

### SUMMARY

The following presents a simplified summary of the disclosure to provide a basic understanding of some exemplary embodiments described in the detailed description.

The present disclosure relates generally glass forming devices and methods and, more particularly, to glass forming devices and methods involving heaters.

In some embodiments, a forming device for forming a glass ribbon can comprise a first wall comprising a first outer surface, a first inner surface, and a first thickness defined between the first outer surface and the first inner surface in a range from about 0.5 millimeters to about 10 millimeters. The forming device can further comprise a second wall comprising a second outer surface, a second inner surface, and a second thickness defined between the second outer surface and the second inner surface in a range from about 0.5 millimeters to about 10 millimeters. The forming device can also comprise an integral junction at a convergence of the first outer surface and the second outer surface, the integral junction comprising a root of the forming device. The forming device can additionally comprise a heater positioned in a cavity at least partially defined by the first inner surface and the second inner surface.

In further embodiments, the heater can be supported by the first wall and the second wall.

In further embodiments, the forming device can further comprise an electrically insulating material at least partially circumscribing the heater.

In even further embodiments, the electrically insulating material can contact the inner surface of the first wall and the inner surface of the second wall.

In further embodiments, the first wall can comprise an electrically conductive material and the second wall can comprise an electrically conductive material.

In even further embodiments, the electrically conductive material of the first wall can comprise platinum or a platinum alloy and the electrically conductive material of the second wall comprises platinum or a platinum alloy.

In further embodiments, the forming device can further comprise a pipe comprising a pipe wall at least partially circumscribing a flow passage and a slot. The slot can extend through the pipe wall. An upstream end of the first wall can be attached to the pipe at a first peripheral location of an outer surface of the pipe wall. An upstream end of the second wall can be attached to the pipe at a second peripheral location of the outer surface of the pipe wall. The slot may be circumferentially located between the first peripheral location and the second peripheral location.

In even further embodiments, the pipe can comprise platinum or a platinum alloy.

In even further embodiments, the forming device can further comprise a support beam supporting the pipe. The support beam can comprise a segment positioned in the cavity between the pipe and the heater.

In further embodiments, the forming device can further comprise a first cooling device facing the first outer surface and a second cooling device facing the second outer surface.

In further embodiments, a method of forming a glass ribbon with the forming device can comprise flowing a first stream of molten material over the first outer surface of the first wall. The method can comprise flowing a second stream of molten material over the second outer surface of the second wall. The first stream of molten material and the second stream of molten material can converge at the root to form a glass ribbon. A liquidus viscosity of the first stream of molten material and a liquidus viscosity of the second stream of molten material can each be in a range from about 5,000 poise to about 30,000 poise. The method can further comprise heating the first wall with the heater to heat an inner portion of the first stream of molten material contacting the first outer surface of the first wall, which can maintain a viscosity of the inner portion of the first stream of molten material below the liquidus viscosity of the first stream of molten material. The method can further comprise heating the second wall with the heater to heat an inner portion of the second stream of molten material contacting the second outer surface of the second wall, which can maintain a viscosity of the inner portion of the second stream of molten material below the liquidus viscosity of the second stream of molten material. The method can also comprise drawing the glass ribbon from the root. The glass ribbon can comprise a thickness in a thickness range from about 100 micrometers to about 2 millimeters.

In even further embodiments, the method can further comprise adjusting a heating rate of the root to maintain a temperature of the root above a liquidus temperature of the first stream of molten material and above a liquidus temperature of the second stream of molten material.

In some embodiments, a method of forming a glass ribbon can comprise flowing a first stream of molten material over a first outer surface of a first wall. The method can comprise flowing a second stream of molten material over a second outer surface of a second wall. The first stream of molten material and the second stream of molten material can converge to form a glass ribbon. A liquidus viscosity of the first stream of molten material and a liquidus viscosity of the second stream of molten material can each be in a range from about 5,000 poise to about 30,000 poise. The method can further comprise heating the first wall to heat an inner portion of the first stream of molten material contacting the first outer surface of the first wall, which can maintain a viscosity of the inner portion of the first stream of molten material below the liquidus viscosity of the first stream of molten material. The method can further comprise heating the second wall to heat an inner portion of the second stream of molten material contacting the second outer surface of the second wall, which can maintain a viscosity of the inner portion of the second stream of molten material below the liquidus viscosity of the second stream of molten material. The method can also comprise drawing the glass ribbon. The glass ribbon can comprise a thickness in a thickness range from about 100 micrometers to about 2 millimeters.

In further embodiments, the method can further comprise an integral junction at a convergence of the first outer surface and the second outer surface comprising a root. The method can further comprise adjusting a heating rate of the root, which can maintain a temperature of the root above a liquidus temperature of the first stream of molten material and above a liquidus temperature of the second stream of molten material.

In further embodiments, the liquidus viscosity of the first and second streams of molten material can be in a range from about 5,000 poise to about 20,000 poise.

In further embodiments, the thickness range can be from about 100 micrometers to about 1.5 millimeters.

In further embodiments, a viscosity of the glass ribbon where the first stream of molten material and the second stream of molten material converge can be in a range from about 8,000 poise to about 35,000 poise.

In further embodiments, the method can further comprise cooling an outer portion of the first stream of molten material opposite the inner portion of the first stream of molten material, which can increase a viscosity of the outer portion of the first stream of molten material above the liquidus viscosity of the first stream of molten material. The method can further comprise cooling an outer portion of the second stream of molten material opposite the inner portion of the second stream of molten material, which can increase a viscosity of the outer portion of the second stream of molten material above the liquidus viscosity of the second stream of molten material.

In even further embodiments, the method can further comprise adjusting a cooling rate of the outer portion of the first stream of molten material to facilitate maintenance of the thickness of the glass ribbon within the thickness range.

In even further embodiments, the method can further comprise adjusting a heating rate of the inner portion of the first stream of molten material to facilitate maintenance of the thickness of the glass ribbon within the thickness range.

In even further embodiments, the method can further comprise adjusting a cooling rate of the outer portion of the second stream of molten material to facilitate maintenance of the thickness of the glass ribbon within the thickness range.

In even further embodiments, the method can further comprise adjusting a heating rate of the inner portion of the second stream of molten material to facilitate maintenance of the thickness of the glass ribbon within the thickness range.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments, and advantages of the present disclosure can be further understood when read with reference to the accompanying drawings, in which:

FIG. 1 schematically illustrates an exemplary embodiment of a glass manufacturing apparatus in accordance with embodiments of the disclosure;

FIG. 2 shows a cross-sectional view of the forming device along line 2-2 of FIG. 1;

FIG. 3 schematically illustrates an exemplary embodiment of a forming device in accordance with embodiments of the disclosure; and

FIG. 4 shows a cross-sectional view of the forming device along line 4-4 of FIG. 3.

### DETAILED DESCRIPTION

Embodiments will now be described more fully hereinafter with reference to the accompanying drawings in which exemplary embodiments are shown. Whenever possible, the same reference numerals are used throughout the drawings to refer to the same or like parts. However, this disclosure may be embodied in many different forms and should not be construed as limited to the embodiments set forth herein. Unless otherwise noted, a discussion of features of one embodiment of the disclosure can apply equally to corresponding features of other embodiments of the disclosure. A glass ribbon from any of these embodiments may then be subsequently divided to provide a plurality of glass articles (e.g., separated glass ribbons) suitable for further processing into an application (e.g., a display application). For example, glass articles (e.g., separated glass ribbons) can be used in a wide range of applications comprising liquid crystal displays (LCDs), electrophoretic displays (EPDs), organic light emitting diode displays (OLEDs), plasma display panels (PDPs), touch sensors, photovoltaics, or the like.

Embodiments of the disclosure herein can provide the technical benefit of drawing (e.g., fusion drawing) low liquidus viscosity molten material from the root as a glass ribbon within predetermined thickness ranges without encountering devitrification of the molten material and/or baggy warp of the glass ribbon. Devitrification can occur when a molten material is cooled below its liquidus temperature for long enough. Embodiments of the disclosure can avoid devitrification by heating the walls (e.g., first wall, second wall) of the forming device to maintain a temperature of an inner portion of the streams of molten material (e.g., first stream, second stream) above the liquidus temperature of the molten material (e.g., the liquidus temperature of the corresponding stream of molten material). Baggy warp can occur when the viscosity of the molten material drawn from the forming device is too low such that a drawn glass ribbon cannot maintain its thickness, registration, and/or shape either under gravity, the force of pull rollers, or both. Embodiments of the disclosure can avoid baggy warp by aggressively cooling an outer portion of the streams of molten material (e.g., first stream, second stream) opposite the inner portion of the respective stream of molten material to increase an effective viscosity where the glass ribbon is drawn. A further technical benefit is that the embodiments of the disclosure can simultaneously reduce (e.g., avoid) devitrification and baggy warp. Additionally, embodiments of the disclosure can provide for more efficient drawing of glass ribbons, for example, by minimizing a draw length for the glass ribbon to obtain its final thickness and/or begin rigid enough to be handled with rollers (e.g., pull rollers).

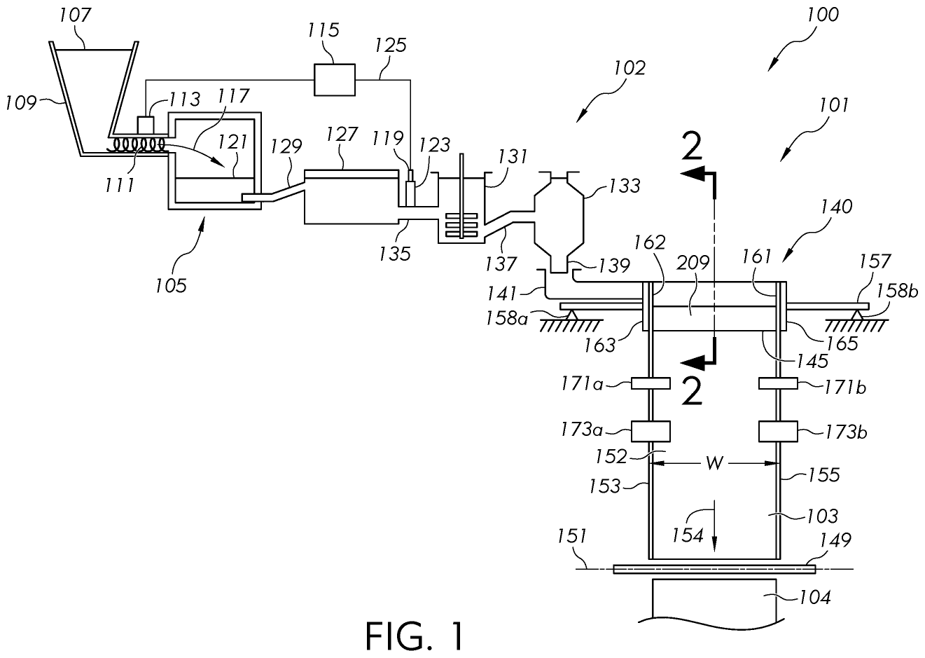

As schematically illustrated in FIG. 1, in some embodiments, a glass manufacturing apparatus 100 can comprise a glass melting and delivery apparatus 102 and a forming apparatus 101 comprising a forming device 140 designed to produce a glass ribbon 103 from a quantity of molten material 121. As used herein, the term “glass ribbon” refers to material after it is drawn from the forming device 140 even when the material is not in a glassy state (i.e., above its glass transition temperature). In some embodiments, the glass ribbon 103 can comprise a central portion 152 positioned between opposite, edge beads formed along a first outer edge 153 and a second outer edge 155 of the glass ribbon 103. Additionally, in some embodiments, a separated glass ribbon 104 can be separated from the glass ribbon 103 along a separation path 151 by a glass separator 149 (e.g., scribe, score wheel, diamond tip, laser). In some embodiments, before or after separation of a separated glass ribbon 104 from the glass ribbon 103, the edge beads formed along the first outer edge 153 and the second outer edge 155 can be removed to provide the central portion 152 as a separated glass ribbon 104 having a more uniform thickness.

In some embodiments, the glass melting and delivery apparatus 102 can comprise a melting vessel 105 oriented to receive batch material 107 from a storage bin 109. The batch material 107 can be introduced by a batch delivery device 111 powered by a motor 113. In some embodiments, a controller 115 can optionally be operated to activate the motor 113 to introduce an amount of batch material 107 into the melting vessel 105, as indicated by arrow 117. The melting vessel 105 can heat the batch material 107 to provide molten material 121. In some embodiments, a glass melt probe 119 can be employed to measure a level of molten material 121 within a standpipe 123 and communicate the measured information to the controller 115 by way of a communication line 125.

Additionally, in some embodiments, the glass melting and delivery apparatus 102 can comprise a first conditioning station comprising a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass melting and delivery apparatus 102 can comprise a third conditioning station comprising a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 through an interior pathway of the third connecting conduit 137 from the mixing chamber 131 to the delivery vessel 133. As further illustrated, in some embodiments, a delivery pipe 139 can be positioned to deliver molten material 121 to forming apparatus 101, for example, the inlet conduit 141 of the forming device 140.

Forming apparatus 101 can comprise a forming device with a forming wedge for drawing (e.g., fusion drawing) the glass ribbon. By way of illustration, the forming device 140 shown and disclosed below can be provided to draw (e.g., fusion draw) the molten material 121 off a bottom edge, defined as a root 145, of a forming wedge 209 to produce a ribbon of molten material 121 that can be drawn into the glass ribbon 103. For example, in some embodiments, the molten material 121 can be delivered from the inlet conduit 141 to the forming device 140. The molten material 121 can then be formed into the glass ribbon 103 based at least in part on the structure of the forming device 140. For example, as shown, the molten material 121 can be drawn off the bottom edge (e.g., root 145) of the forming device 140 along a draw path extending in a draw direction 154 of the glass manufacturing apparatus 100. In some embodiments, edge directors 163, 165 can direct the molten material 121 off the forming device 140 and define, at least in part, a width “W” of the glass ribbon 103. In some embodiments, the width “W” of the glass ribbon 103 can extend between the first outer edge 153 of the glass ribbon 103 and the second outer edge 155 of the glass ribbon 103. In some embodiments, the width “W” of the glass ribbon 103 can be about 20 millimeters (mm) or more, about 50 mm or more, about 100 mm or more, about 500 mm or more, about 1,000 mm or more, about 2,000 mm or more, about 3,000 mm or more, about 4,000 mm or more, although other widths can be provided in further embodiments. In some embodiments, the width “W” of the glass ribbon 103 can be in a range from about 20 mm to about 4,000 mm, from about 50 mm to about 4,000 mm, from about 100 mm to about 4,000 mm, from about 500 mm to about 4,000 mm, from about 1,000 mm to about 4,000 mm, from about 2,000 mm to about 4,000 mm, from about 3,000 mm to about 4,000 mm, from about 2,000 mm to about 3,000 mm, from about 50 mm to about 3,000 mm, from about 100 mm to about 3,000 mm, from about 500 mm to about 3,000 mm, from about 1,000 mm to about 3,000 mm, from about 2,000 mm to about 3,000 mm, from about 2,000 mm to about 2,500 mm, and all ranges and subranges therebetween.

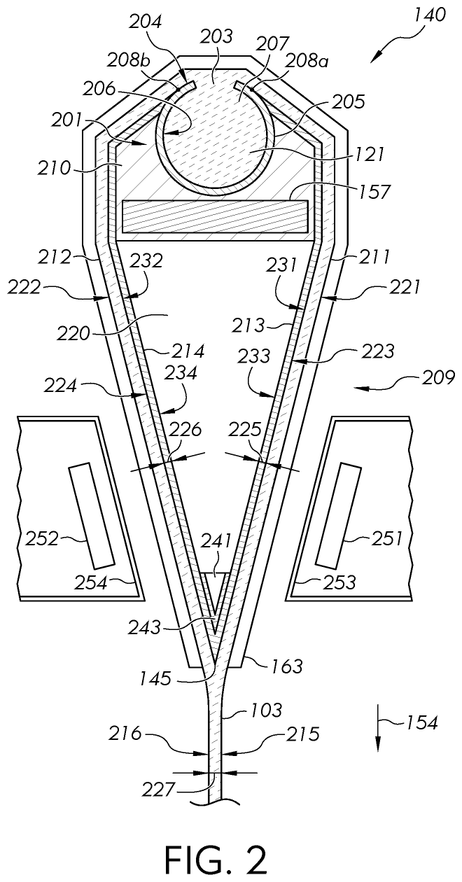

FIG. 2 shows a cross-sectional view of the forming apparatus 101 (e.g., forming device 140) along line 2-2 of FIG. 1. In some embodiments, the forming device 140 can include a pipe 201 oriented to receive the molten material 121 from the inlet conduit 141. The forming device 140 can further include the forming wedge 209 comprising a first wall 213 and a second wall 214 comprising a pair of downwardly inclined converging surface portions extending between opposed ends 161, 162 (See FIG. 1) of the forming wedge 209. The first wall 213 and the second wall 214 can comprise the pair of downwardly inclined converging surface portions of the forming wedge 209 converging along the draw direction 154 to intersect along the root 145 of the forming device 140. As used herein, locations on the forming devices 140, 301 of the disclosure and parts therein referred to as upstream or downstream relative to another location based on the draw direction. Additionally, in some embodiments, the molten material 121 can flow into and along the pipe 201 of the forming device 140. As shown in FIG. 2, the pipe 201 can comprise a pipe wall 205 comprising an inner surface 206 defining a region 207. As shown, the pipe wall 205 at least partially circumscribes a flow passage comprising the region 207. As shown, an outer surface 204 of the pipe wall 205 can comprise a slot 203. The slot 203 may comprise a single continuous slot although a plurality of slots may be provided that are aligned perpendicular to the view shown in FIG. 2. In some embodiments, the slot 203 may include enlarged ends. In some embodiments, although not shown, the slot 203 can vary along in the direction perpendicular to the view shown in FIG. 2 by decreasing, for example, intermittently or continuously decreasing from an intermediate portion to a first outer end portion and a second outer end portion. Furthermore, although not shown, the slot 203 or can include multiple rows of slots that may extend perpendicular to the view shown in FIG. 2 and parallel to one another.

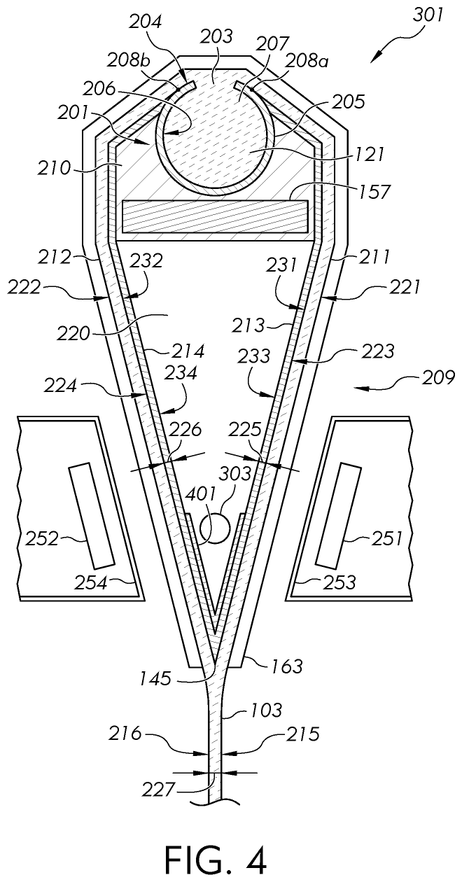

As shown in FIGS. 2 and 4, the slot 203 can comprise a through-slot that extends through the pipe wall 205. As shown, in some embodiments, the slot 203 can be open to the outer surface 204 and the inner surface 206 of the pipe wall 205 to provide fluid communication between the region 207 and the outer surface 204 of the pipe wall 205. As can be appreciated in FIGS. 2 and 4, the slot 203 (optionally comprising a plurality of slots) can be provided in the outer surface 204 of the pipe wall 205 at the uppermost apex of the pipe 201 in any of the embodiments of the disclosure. In further embodiments, the slot (optionally comprising a plurality of slots) may bisect the pipe 201 and/or root 145. Without wishing to be bound by theory, bisecting the pipe 201 and/or root 145 with the slot (optionally comprising a plurality of slots) along the uppermost apex can help evenly divide the molten material exiting the slot(s) into oppositely flowing streams (e.g., first stream 211 of molten material 121, second stream 212 of molten material 121).

The pipe wall 205 of the pipe 201 may comprise an electrically conductive material. As used herein, a material is electrically conductive if it comprises a resistivity at 20° C. of about 0.0001 ohm-meters (Ωm) or less (e.g., a conductivity of about 10,000 Siemens-per-meter (S/m) or more). Embodiments of electrically conductive materials include manganese, nickel-chrome alloys (e.g., nichrome), steel, titanium, iron, nickel, zinc, tungsten, gold, copper, silver, platinum, rhodium, iridium, osmium, palladium, ruthenium and combinations thereof. In further embodiments, the pipe wall 205 of the pipe 201 may comprise platinum or a platinum alloy, although other materials may be provided that are compatible with the molten material and provide structural integrity at elevated temperatures. In some embodiments, the platinum alloy may comprise platinum-rhodium, platinum-iridium, platinum-palladium, platinum-gold, platinum-osmium, platinum-ruthenium, and combinations thereof. In some embodiments, the platinum or platinum alloy may also comprise refractory metals, for example, molybdenum, rhenium, tantalum, titanium, tungsten, ruthenium, osmium, zirconium, zirconium dioxide (zirconia), and/or alloys thereof. In further embodiments, the platinum or platinum alloy can comprise an oxide dispersion-strengthened material. In further embodiments, the entire pipe wall 205 may comprise or consist essentially of platinum or a platinum alloy. As such, in some embodiments, the conduit can comprise a platinum pipe 201 comprising the pipe wall 205 defining the region 207. In some embodiments, the wall may comprise one or more of the above materials without platinum. To reduce material costs of the pipe 201 (e.g., platinum pipe), a thickness of the pipe wall 205 of the conduit can be in a range from about 0.5 millimeter (mm) to about 10 mm, from about 0.5 mm to about 7 mm, from about 0.5 mm to about 3 mm, from about 1 mm to about 10 mm, from about 1 mm to about 7 mm, from about 3 mm to about 10 mm, from about 3 mm to about 7 mm, or any range or subrange therebetween. Providing the pipe 201 with the thickness of the pipe wall 205 within any of the above ranges can provide a thickness that is large enough to provide a desired level of structural integrity for the pipe 201 while also providing a thickness that can be minimized to reduce the costs of the materials to produce the pipe 201 (e.g., platinum pipe).

The pipe wall 205 of the pipe 201 can comprise a wide range of sizes, shapes, and configurations to reduce manufacturing and/or assembly costs and/or increase the functionality of the pipe 201. For instance, as shown, the outer surface 204 and/or the inner surface 206 of the pipe wall 205 may comprise a circular shape, although other curvilinear shapes (e.g., oval) or polygonal shapes may be provided in further embodiments. Providing a curvilinear shape, (e.g., a circular shape) of both the outer surface 204 and the inner surface 206 can provide a pipe wall 205 with a constant thickness and can provide a pipe wall 205 with high structural strength and help promote consistent flow of molten material 121 through the region 207 of the pipe 201. Furthermore, as will be appreciated from FIGS. 2 and 4, the outer surface 204 and/or the inner surface 206 of the pipe 201 can include geometrically similar circular shapes (or other shapes) along its length in a direction perpendicular to the view shown in FIGS. 2 and 4. In such embodiments, the flow rate through the slot 203 can be controlled (e.g., maintained substantially the same) by modifying the width of the slot 203.

The pipe 201 of any of the embodiments of the disclosure can comprise a continuous pipe although a segmented pipe may be provided in further embodiments. For instance, the pipe 201 of the can comprise a continuous pipe that is not segmented along its length. Such a continuous pipe may be beneficial to provide a seamless pipe with increased structural strength. In some embodiments, a segmented pipe may be provided. For instance, the pipe 201 of the forming device 140, 301 can optionally comprise pipe segments that can be connected together in series at joints between abutting ends of pairs of adjacent pipe segments. In some embodiments, the joints may comprise welded joints to integrally join the pipe segments as an integral pipe. In some embodiments, the joints may comprise a diffusion-bonded joint, a male/female joint, or a threaded joint. Providing the pipe 201 as a series of pipe segments may simplify fabrication of the pipe 201 in some applications.

In some embodiments, although not shown, forming device may comprise a trough instead of a pipe. In such embodiments, the molten material 121 can flow into and along a trough of a forming device. The molten material 121 can then overflow from the trough by simultaneously flowing over corresponding weirs and downward over the outer surfaces of the corresponding weirs.

As shown in FIGS. 2 and 4, the forming wedge 209 can include the first wall 213 defining a first outer surface 223 and the second wall 214 defining a second outer surface 224. As shown in FIGS. 2 and 4, in some embodiments, an upstream end of the first wall 213 (e.g., platinum wall) can be attached to the pipe wall 205 of the pipe 201 (e.g., platinum pipe) via a first interface at a first peripheral location 208a of the outer surface 204 of the pipe 201. Likewise, an upstream end of the second wall 214 (e.g., platinum wall) can be attached to the pipe wall 205 of the pipe 201 (e.g., platinum pipe) via a second interface at a second peripheral location 208b of the outer surface 204 of the pipe 201. As shown, the first peripheral location 208a and the second peripheral location 208b can be each located downstream from the slot 203 of the pipe 201. Consequently, the slot 203 can be circumferentially located between the first peripheral location 208a and the second peripheral location 208b. In some embodiments, the upstream end of the first wall 213 and the upstream end of the second wall 214 can be integrally joined to the pipe wall 205 of the pipe 201 and machined to have a smooth corresponding interface between the outer surface 204 of the pipe 201 and the outer surface of the walls (e.g., first outer surface 223 of the first wall 213, second outer surface 224 of the second wall 214). In some embodiments, integrally joining the upstream end of the first wall 213 and the upstream end of the second wall 214 to the pipe wall 205 can comprise forming a joint, for example, a welded joint, a diffusion bonded joint, a male/female joint, or a threaded joint.

In some embodiments, as shown in FIGS. 2 and 4, the upstream portion of the first wall 213 and the upstream portion of the second wall 214 can initially flare away from one another along the draw direction 154 from the corresponding interface with the pipe 201. Without wishing to be bound by theory, flaring the first wall and second wall away from one another can facilitate the flow of molten material along the draw direction while also allowing increased space for the support beam in some embodiments. In some embodiments, although not shown, the upstream portions of the first wall and second wall can be parallel with one another.

In some embodiments, as shown in FIGS. 2 and 4, the first outer surface 223 and the second outer surface 224 can converge in the draw direction 154 to form a root 145 of the forming wedge 209. In some embodiments, the root 145 may comprise an integral junction at a convergence of the first outer surface 223 and the second outer surface 224. In some embodiments, the integral junction may comprise a unitary (e.g., monolithic) material or may comprise a joint. In further embodiments, joints may comprise a diffusion-bonded joint, a male/female joint, or a threaded joint.

In some embodiments, the first wall 213 and/or the second wall 214 of the forming device 140, 301 can comprise an electrically conductive material, as defined above. In further embodiments, the first wall 213 and/or the second wall 214 may comprise platinum and/or a platinum alloy similar or identical to the composition of the pipe 201 discussed above, although different compositions may be employed in further embodiments. In even further embodiments, the first wall 213 and the second wall 214 can each comprise platinum. In further embodiments, the first wall 213 and/or the second wall 214 may comprise one or more of the materials discussed above for the pipe 201 without containing platinum. A thickness 225 of the first wall 213 can be defined between the first outer surface 223 and a first inner surface 233. A thickness 226 of the second wall 214 can be defined between the second outer surface 224 and a second inner surface 234. To reduce material costs, the thickness 225 of the first wall 213 and/or the thickness 226 of the second wall 214 (e.g., platinum walls) can, for example, be within a range 0.5 mm to about 10 mm, from about 0.5 mm to about 7 mm, from about 0.5 mm to about 3 mm, from about 1 mm to about 10 mm, from about 1 mm to about 7 mm, from about 3 mm to about 10 mm, from about 3 mm to about 7 mm, or any range or subrange therebetween. A reduced thickness can result in overall reduced material costs.

As shown in FIGS. 2 and 4, the first wall 213 may comprise the first inner surface 233 opposite the first outer surface 223 of the first wall 213. As shown, the second wall 214 may comprise the second inner surface 234 opposite the second outer surface 224 of the second wall 214. The first inner surface 233 and the second inner surface 234 may at least partially define a cavity 220 within the forming device 140, 301, as shown in FIGS. 2 and 4. In some embodiments, the cavity 220 may be further defined by the pipe wall 205 of the pipe 201. As discussed below, a support beam 157 and/or a heater 241, 303 may be positioned in the cavity 220 at least partially defined by the first inner surface 233 and the second inner surface 234.

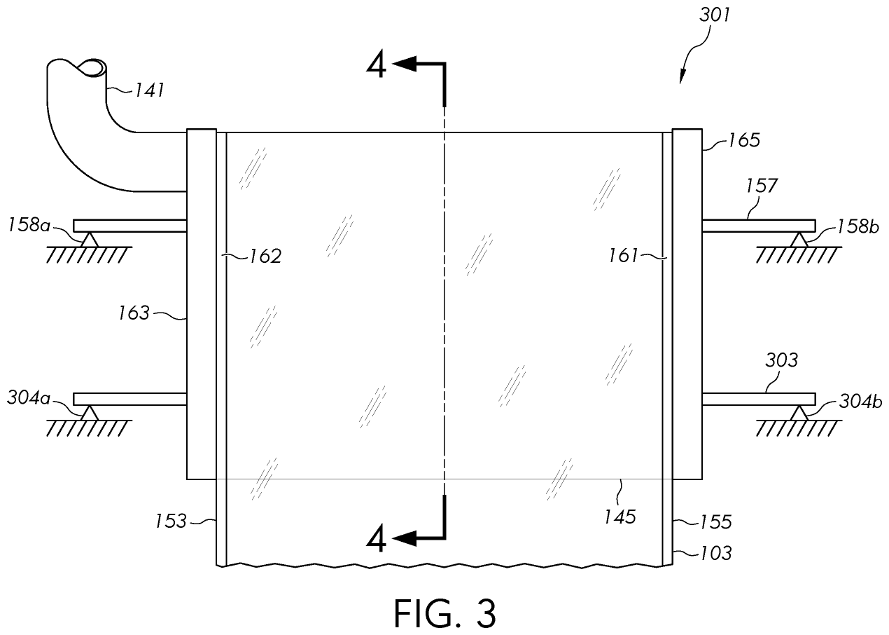

As shown in FIGS. 2 and 4, the support beam 157 positioned in the cavity 220 can support a weight of the pipe 201 and the molten material 121 within the region 207. In further embodiments, in addition to supporting the weight of the pipe 201 and the molten material 121 associated with the pipe 201, the support beam 157 may be configured to help maintain the shape and/or dimensions of the pipe 201, for example, the shape and dimensions of the slot 203. In some embodiments, the support beam 157 can extend laterally outside of the width of the root 145 to be supported (e.g., simply supported) at opposite locations 158a, 158b as shown in FIGS. 1 and 3. As such, the support beam 157 can be longer than the width “W” of the formed glass ribbon 103 and can extend through the cavity 220 laterally extending through the forming device 140, 301 to fully support the forming device 140, 301. Additionally, as shown in FIGS. 2 and 4, the support beam 157 can be positioned between the first wall 213 and the second wall 214 within the cavity 220 of the forming device 140, 301, which can provide the walls with sufficient structural integrity to resist deformation in use despite the low thickness of the first wall 213 and/or second wall 214. As such, the structure of the first wall 213 and the second wall 214 can be maintained by the support beam 157 positioned therebetween. Furthermore, the first wall 213 and the second wall 214 converge in the draw direction 154 to form the root 145 wherein a strong triangular construction can be formed by the first wall 213 and the second wall 214. As such, a structurally rigid configuration can be achieved with thin walls within the ranges specified above.

Support beams of the disclosure can, for example, be provided as a single monolithic support beam. In some embodiments, although not shown, the support beam can optionally include a first support beam and a second support beam that supports the first support beam. In further embodiments, the first support beam and second support beam can comprise a stack of support beams where the first support beam is stacked on top of the second support beam. Providing a stack of support beams can simplify and/or reduce the cost of fabrication. For instance, in some embodiments, the second support beam can be longer than the first support beam such that opposite end portions of the second support beam can extend laterally outside of the width of the root 145 to be supported (e.g., simply supported) at opposite locations (e.g., locations 158a, 158b). As such, the second support beam can be longer than the width “W” of the formed glass ribbon 103 and can extend through the cavity 220 laterally extending through the forming device 140, 301 to fully support the forming device 140, 301. Furthermore, the second support beam may comprise a shape, for example, the illustrated rectangular shape although a hollow shape, a shape of an I-beam or another shape may be provided to reduce material costs while still providing a high bending moment of inertia for the support beam. Furthermore, the first support beam can be fabricated with a shape to support the conduit to help maintain the shape and dimensions of the conduit as discussed above.

In some embodiments, the support beam 157 can comprise a support material comprising one or more ceramics. An exemplary embodiment of a ceramic material for the support beam can comprise silicon carbide (SiC). In some embodiments, other ceramics (e.g., oxides, carbides, nitrides, oxynitrides) may be used in the support beam. In some embodiments, the support material can be designed to maintain its mechanical properties and dimensional stability at a temperature of about 1200° C. or more, about 1300° C. or more, about 1400° C. or more, about 1500° C. or more, about 1600° C. or more, or about 1700° C. or less. In further embodiments, the support beam 157 can be fabricated from a support material with a creep rate from 1×10⁻¹² s⁻¹ to 1×10⁻¹⁴ s⁻¹ under a pressure in a range from about 1 MegaPascal (MPa) to 5 MPa at a temperature of about 1400° C. or more. Such a support material can provide sufficient support for the pipe and molten material carried by the conduit at high temperatures (e.g., 1400° C.) with minimal creep to provide a forming device 140, 301 that minimizes use of platinum or other expensive refractory materials ideal for physically contacting the molten material without contaminating the molten material while providing a support beam 157 fabricated from an inexpensive material that can withstand large stresses under the weight of the forming vessel and molten material carried by the forming device 140, 301. At the same time, the support beam 157 fabricated from the material discussed above can withstand creep under high stress and temperature to allow maintenance of the position and shape of the conduit and walls (e.g., platinum walls) associated with the conduit. In further embodiments, the support beam 157 may comprise the first support beam and the second support beam, and the first support beam and the second support beam may be fabricated from substantially the same or identical material although alternative materials may be provided in further embodiments.

In some embodiments, the material of the first wall 213 and/or second wall 214 may be incompatible for physical contact with the material of the support beam 157. For example, in some embodiments, the first wall 213 and/or second wall 214 can comprise platinum (e.g., platinum or a platinum alloy) and the support beam 157 can comprise a support material (e.g., silicon carbide) that may corrode or otherwise chemically react with the platinum of the first wall 213 and/or second wall 214 if the platinum were permitted to contact the support beam 157. As such, in some embodiments, to avoid contact between incompatible materials, any portion of the wall (e.g., first wall 213, second wall 214) and any portion of the pipe 201 may be prevented from physically contacting any portion of the support beam 157. As shown, for example, in FIGS. 2 and 4, the first wall 213 and the second wall 214 are each spaced from physically contacting any portion of the support beam 157. Furthermore, the pipe 201 can be spaced from physically contacting any portion of the support beam 157. Various techniques can be used to space the wall from the support beam 157. For example, pillars or ribs may be provided to provide spacing.

In some embodiments, as shown, a layer of intermediate material 210 may be provided between a wall (e.g., the first wall 213, the second wall 214) and the support beam 157 to space the corresponding wall (e.g., the first wall 213, the second wall 214) from contacting the support beam 157. In further embodiments, the layer of intermediate material 210 may be continuously provided between all portions of the first wall 213 and/or second wall 214 and adjacent spaced portions of the support beam 157. In some embodiments, as shown, a layer of intermediate material 210 may be provided between the pipe 201 and the support beam 157 to space the pipe 201 from contacting the support beam 157. In further embodiments, the layer of intermediate material 210 may be continuously provided between all portions of the pipe 201 and adjacent spaced portion of the support beam 157. Without wishing to be bound by theory, providing a continuous layer of intermediate material 210 can facilitate even support across all portions of the first wall 213, the second wall 214, and the pipe 201 by the support beam 157 spaced from the aforementioned structures. Various materials can be used as the intermediate material 210 depending on the materials of the walls (e.g., first wall 213, second wall 214) and the support beam 157. For instance, the intermediate material 210 can comprise a material that is compatible for contacting the pipe 201, the first wall 213, and/or the second wall 214 (e.g., platinum) and the support member (e.g., silicon carbide) under high temperature and pressure conditions associated with containing and guiding the molten material 121 with the forming device 140, 301. In some embodiments, the intermediate material 210 can comprise a refractory material. Exemplary embodiments of suitable refractory materials comprise zirconia and alumina. In some embodiments, other refractory materials (e.g., oxides, quartz, mullite) may be used. Thus, in further embodiments, platinum or platinum alloy walls (e.g., first wall 213, second wall 214) and platinum pipe (e.g., pipe 201) can be spaced from physically contacting any portion of a support beam 157 (e.g., comprising silicon carbide) by way of a layer of intermediate material 210 (e.g., alumina).

As shown in FIGS. 2 and 4, the forming device 140, 301 can further comprise a heater 241, 303 positioned in the cavity 220 of the forming device 140, 301. In some embodiments, as shown in FIG. 2, the heater 241 can be supported by the first wall 213 and/or second wall 214 of the forming device 140. In some embodiments, as shown, the heater 241 can be supported by the lowest portions of the first inner surface 233 of the first wall 213 and the second inner surface 234 of the second wall 214 that define the lowest portion of the cavity 220. In some embodiments, as shown in FIGS. 3-4, the heater 303 can be supported independently from the rest of the forming body. For example, as shown in FIG. 3, the heater 303 can extend laterally outside of the width of the root 145 to be supported (e.g., simply supported) at opposite locations 304a, 304b. As such, the heater 303 can be longer than the width “W” of the formed glass ribbon 103 and can extend through a cavity 220 laterally extending through the forming device 301. In some embodiments, as shown in FIG. 2, a cross-section of the heater 241 may comprise a polygonal shape. The polygonal shape of the heater 241 can facilitate seating of the heater 241 within the lowest portion of the cavity 220. In further embodiments, as shown, the cross-section of the heater 241 may comprise a triangular shape. In further embodiments, although not shown, the cross-section of the heater may comprise a quadrilateral, pentagonal, hexagonal, etc. shape. In some embodiments, as shown in FIG. 4, a cross-section of the heater 303 may comprise a curvilinear shape. In further embodiments, as shown in FIG. 4, the cross-section of the heater 303 may comprise a substantially circular shape. In further embodiments, although not shown, the cross-section of the heater may comprise an aspherical shape (e.g., an ellipse). In some embodiments, although not shown, the cross-section of the heater may comprise a combination of polygonal and curvilinear shapes.

The heater 241, 303 may comprise a metal or a refractory material (e.g., ceramic). Exemplary embodiments of metals include chromium, molybdenum, tungsten, platinum, platinum, rhodium, iridium, osmium, palladium, ruthenium, gold, and combinations (e.g., alloys) thereof. Additional exemplary embodiments of metals (e.g., alloys) include nickel-chromium alloys (e.g., nichrome), iron-chromium-aluminum alloys, and platinum alloys as described above. Exemplary embodiments of ceramics include silicon carbide, chromium disilicide (CrSi₂), molybdenum disilicide (MoSi₂), tungsten disilicide (WSi₂), alumina, barium titanate, lead titanate, zirconia, yttrium oxide, and combinations thereof In some embodiments, the heater 241, 303 can comprise platinum or a platinum alloy. In some embodiments, the heater 241, 303 can comprise silicon carbide (e.g., a globar). In some embodiments, the heater 241, 303 can comprise molybdenum disilicide. In some embodiments, as shown in FIGS. 2 and 4, the heater 241, 303 can comprise a single (e.g., monolithic) material. In some embodiments, although not shown, the heater may comprise a cavity inside of an outer periphery of material. In further embodiments, fluid (e.g., air, steam) may be circulated through the cavity inside the heater.

In some embodiments, as shown in FIGS. 2 and 4, an electrically insulating material 243, 401 may at least partially circumscribe the heater 241, 303. As used herein, a material is electrically insulating if it comprises a resistivity of about 10,000 Ωm or more (e.g., a conductivity of about 0.0001 S/m or less). Throughout the disclosure, a first material need not contact a second material in order for the first material at least partially circumscribes the second material; rather, a first material at least partially circumscribes a second material if lines extending away from the perimeter of the second material encounter the first material for about 10% or more of the perimeter (e.g., circumference) of the second material in a cross-section of a device. For example, with reference to FIG. 2, the electrically insulating material 243 at least partially circumscribes the heater 241 because lines extending from the perimeter (e.g., outer peripheral surface) of the heater 241 would encounter the electrically insulating material for about 10% or more of the perimeter in the cross-section shown. In FIG. 4, the electrically insulating material 401 at least partially circumscribes the heater 303 although the electrically insulating material 401 is not in contact with the heater 303 because lines extending from the perimeter (e.g., circumference) of the heater 241 would encounter the electrically insulating material 401 for about 10% or more of the perimeter in the cross-section shown. In some embodiments, as shown in FIG. 2, the electrically insulating material 243 may at least partially circumscribe the heater 241 for about 25% or more, or about 50% or more of the perimeter of heater 241. In further embodiments, although not shown, the electrically insulating material may at least partially circumscribe the heater by entirely circumscribing the heater. In some embodiments, as shown in FIG. 2, the heater 241 may contact the electrically insulating material 243. In some embodiments, as shown in FIGS. 2 and 4, the electrically insulating material may contact the first wall 213 and the second wall 214 by contacting the first inner surface 233 and the second inner surface 234 of the forming device 140, 301. In some embodiments, as shown in FIGS. 2 and 4, the heater 241, 303 may be positioned between the electrically insulating material 243, 401 and the support beam 157. In some embodiments, as shown, the electrically insulating material may be provided between a wall (e.g., the first wall 213, the second wall 214) and heater 241, 303 to electrically isolate the heater 241, 303 from the corresponding wall (e.g., the first wall 213, the second wall 214) and to prevent the corresponding wall from contacting the heater 241, 303 or particulate (e.g., falling particulate) from the heater. In further embodiments, the electrically insulating material 243, 401 may be continuously provided between all portions of the first wall 213 and/or second wall 214 and adjacent spaced portions of the heater 241, 303. The electrically insulating material 243, 401 can comprise any of the materials listed above for the intermediate material 210 that are electrically insulating, although other materials for the electrically insulating material may be provided in further embodiments.

As shown in FIGS. 2 and 4, the forming device 140, 301 can further comprise a first cooling device 251 and/or a second cooling device 252. As used herein, a cooling device refers to any device capable of lowering the temperature of the molten material. In some embodiments, the first cooling device 251 and/or the second cooling device 252 may comprise piping through which cooled liquid is circulated. In some embodiments, the first cooling device 251 and/or the second cooling device 252 may comprise electrical resistance heaters or piping through which a heated fluid circulates, where the cooling device(s) serve to lower the temperature of the molten material 121. The first cooling device 251 can face the first outer surface 223 of the first wall 213. The second cooling device 252 can face the second outer surface 224 of the second wall 214.

In some embodiments, a first cover 253 may be positioned between the first cooling device 251 and the first stream 211 of molten material 121. In some embodiments, a second cover 254 may be positioned between the second cooling device 252 and the second stream 212 of molten material 121. The first cover 253 and/or the second cover 254 can diffuse the cooling effect of the respective cooling device, thereby distributing the cooling effect more evenly across the width of the respective stream of molten material 121. In some embodiments, the first cooling device 251 may comprise a plurality of cooling devices positioned across the width of the first stream 211 of molten material 121. In some embodiments, the second cooling device 252 may comprise a plurality of cooling devices positioned across the width of the second stream 212 of molten material 121. In some embodiments, the first cooling device 251 may comprise a plurality of cooling devices positioned along the draw direction 154. In some embodiments, the second cooling device 252 may comprise a plurality of cooling devices positioned along the draw direction 154.

Methods of fabricating the glass ribbon 103 from the quantity of molten material 121 with any of the forming devices 140, 301 discussed above can include flowing the molten material 121 within the region 207 of the pipe 201. Methods can further include flowing the molten material 121 through the slot 203 from the region 207 of the pipe 201 as a first stream 211 of molten material 121 and a second stream 212 of molten material 121. Methods can still further include flowing the first stream 211 of molten material 121 over the first outer surface 223 of the first wall 213 along the draw direction 154 and the second stream 212 of molten material 121 over the second outer surface 224 along the draw direction 154. The first stream 211 of molten material 121 and the second stream 212 of molten material 121 can converge in the draw direction 154. In some embodiments, the first stream 211 of molten material 121 and the second stream 212 of molten material 121 can converge at the root 145 to form a glass ribbon 103. Methods can then include drawing the glass ribbon 103 from the root 145 of the forming wedge 209.

In some embodiments, the glass ribbon 103 can traverse along draw direction 154 at about 1 millimeter per second (mm/s) or more, about 10 mm/s or more, about 50 mm/s or more, about 100 mm/s or more, or about 500 mm/s or more, for example, in a range from about 1 mm/s to about 500 mm/s, from about 10 mm/s to about 500 mm/s, from about 50 mm/s to about 500 mm/s, from about 100 mm/s to about 500 mm/s, and all ranges and subranges therebetween. In some embodiments, the glass separator 149 (see FIG. 1) can then separate the glass sheet from the glass ribbon 103 along the separation path 151. As illustrated, in some embodiments, the separation path 151 can extend along the width “W” of the glass ribbon 103 between the first outer edge 153 and the second outer edge 155. Additionally, in some embodiments, the separation path 151 can extend perpendicular to the draw direction 154 of the glass ribbon 103. Moreover, in some embodiments, the draw direction 154 can define a direction along which the glass ribbon 103 can be drawn from the forming device 140.

As shown in FIGS. 2 and 4, the glass ribbon 103 can be drawn from the root 145 with a first major surface 215 of the glass ribbon 103 and a second major surface 216 of the glass ribbon 103 facing opposite directions and defining a thickness 227 (e.g., average thickness) of the glass ribbon 103. In some embodiments, the thickness 227 of the glass ribbon 103 can be about 2 millimeters (mm) or less, about 1.5 mm or less, about 1.2 mm or less, about 1 mm or less, about 0.5 mm or less, about 300 micrometers (um) or less, or about 200 μm or less, although other thicknesses may be provided in further embodiments. In some embodiments, the thickness 227 of the glass ribbon 103 can be about 100 μm or more, about 200 μm or more, about 300 μm or more, about 600 μm or more, about 1 mm or more, about 1.2 mm or more, or about 1.5 mm or more, although other thicknesses may be provided in further embodiments. For example, in some embodiments, the thickness 227 of the glass ribbon 103 can be in a thickness range from about 100 μm to about 2 mm, from about 200 μm to about 2 mm, from about 300 μm to about 2 mm, from about 600 μm to about 2 mm, from about 1 mm to about 2 mm, from about 100 μm to about 1.5 mm, from about 200 μm to about 1.5 mm, from about 300 μm to about 1.5 mm, from about 600 μm to about 1.5 mm, from about 1 mm to about 1.5 mm, from about 100 μm to about 1.2 mm, from about 200 μm to about 1.2 mm, from about 600 μm to about 1.2 mm, or any range or subrange of thicknesses therebetween.

Exemplary molten materials, which may be free of lithia or not, comprise soda lime molten material, aluminosilicate molten material, alkali-aluminosilicate molten material, borosilicate molten material, alkali-borosilicate molten material, alkali-alumniophosphosilicate molten material, and alkali-aluminoborosilicate glass molten material. In one or more embodiments, a molten material 121 may comprise, in mole percent (mol %): SiO₂ in a range from about 40 mol % to about 80%, Al₂O₃ in a range from about 10 mol % to about 30 mol %, B₂O₃ in a range from about 0 mol % to about 10 mol %, ZrO₂ in a range from about 0 mol % to about 5 mol %, P₂O₅ in a range from about 0 mol % to about 15 mol %, TiO₂ in a range from about 0 mol % to about 2 mol %, R₂O in a range from about 0 mol % to about 20 mol %, and RO in a range from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In some embodiments, a molten material 121 may optionally further comprise in a range from about 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. In some embodiments, the glass ribbon 103 and/or glass sheets formed from the may be transparent, meaning that the glass ribbon 103 drawn from the molten material 121 can comprise an average light transmission over the optical wavelengths from 400 nanometers (nm) to 700 nm of about 85% or greater, about 86% or greater, about 87% or greater, about 88% or greater, about 89% or greater, about 90% or greater, about 91% or greater, or about 92% or greater.

Throughout the disclosure, a liquidus temperature of a molten material is the lowest temperature above which no crystal can exist within the molten material (e.g., the molten material is completely liquid). In other words, the liquidus temperature is the maximum temperature at which crystals can coexist with a liquid (e.g., melt, molten) phase of the molten material at thermodynamic equilibrium. Throughout the disclosure, a liquidus viscosity of a molten material is a viscosity of the molten material when the molten material is at the liquidus temperature. In some embodiments, a liquidus viscosity of the molten material 121 can be substantially the same as a liquidus viscosity of the first stream 211 of molten material 121 and/or a liquidus viscosity of the second stream 212 of molten material 121. In some embodiments, the liquidus viscosity of the molten material 121 (e.g., liquidus viscosity of the first stream 211 of molten material 121, liquidus viscosity of the second stream 212 of molten material 121) can be about 5,000 poise or more, about 8,000 poise or more, about 10,000 poise or more, about 15,000 poise or more, or about 20,000 poise or more. In some embodiments, the liquidus viscosity of the molten material 121 (e.g., liquidus viscosity of the first stream 211 of molten material 121, liquidus viscosity of the second stream 212 of molten material 121) can be about 200,000 poise or less, about 100,000 poise or less, about 50,000 poise or less, about 35,000 poise or less, about 30,000 poise or less, about 25,000 poise or less, or about 20,000 poise or less. In some embodiments, the liquidus viscosity of the molten material 121 (e.g., liquidus viscosity of the first stream 211 of molten material 121, liquidus viscosity of the second stream 212 of molten material 121) can be in a range from about 5,000 poise to about 200,000 poise, from about 5,000 poise to about 100,000 poise, from about 5,000 to about 50,000, from about 5,000 poise to about 35,000 poise, from about 5,000 poise to about 30,000 poise, from about 5,000 poise to about 25,000 poise, from about 5,000 poise to about 20,000 poise, from about 8,000 poise to about 100,000 poise, from about 8,000 poise to about 50,000 poise, from about 8,000 poise to about 30,000 poise, from about 8,000 poise to about 25,000 poise, from about 8,000 poise to about 20,000 poise, from about 10,000 poise to about 100,000 poise, from about 10,000 poise to about 50,000 poise, from about 10,000 poise to about 30,000 poise, from about 10,000 poise to about 25,000 poise, from about 10,000 poise to about 20,000 poise, from about 15,000 poise to about 30,000 poise, from about 15,000 poise, to about 25,000 poise, from about 15,000 poise to about 20,000 poise, from about 20,000 poise to about 30,000 poise, or any range or subrange therebetween.

Methods can further comprise heating the first wall 213 of the forming device 140, 301 to heat an inner portion 231 of the first stream 211 of molten material 121. In some embodiments, heating the first wall 213 to heat the inner portion 231 of the first stream 211 of molten material 121 can maintain a viscosity of the inner portion 231 of the first stream 211 of molten material 121 below the liquidus viscosity of the first stream 211 of molten material 121. In further embodiments, maintaining a viscosity of the inner portion 231 of the first stream 211 of molten material 121 can comprise decreasing the viscosity of the inner portion 231 of the first stream 211 of molten material 121 by increasing a temperature of the inner portion 231 of the first stream 211 of molten material 121. In some embodiments, the heater 241, 303 can heat the first wall 213 to heat the inner portion 231 of the first stream 211 of molten material 121, which can maintain a viscosity of the inner portion 231 of the first stream 211 of molten material 121 below the liquidus viscosity of the first stream 211 of molten material 121. In some embodiments, methods can further comprise adjusting a heating rate of the inner portion 231 of the first stream 211 of molten material 121 to facilitate maintenance of the thickness 227 of the glass ribbon 103 within the thickness range discussed above. In further embodiments, adjusting a heating rate of the inner portion 231 of the first stream 211 of molten material 121 can comprise adjusting the heating rate of the heater 241, 303 to facilitate maintenance of the thickness 227 of the glass ribbon 103 within the thickness range discussed above.

Methods can further comprise heating the second wall 214 of the forming device 140, 301 to heat an inner portion 232 of the second stream 212 of molten material 121. In some embodiments, heating the second wall 214 to heat the inner portion 232 of the second stream 212 of molten material 121 can maintain a viscosity of the inner portion 232 of the second stream 212 of molten material 121 below the liquidus viscosity of the second stream 212 of molten material 121. In further embodiments, maintaining a viscosity of the inner portion 232 of the second stream 212 of molten material 121 can comprise decreasing the viscosity of the inner portion 232 of the second stream 212 of molten material 121 by increasing a temperature of the inner portion 232 of the second stream 212 of molten material 121. In some embodiments, the heater 241, 303 can heat the second wall 214 to heat the inner portion 232 of the second stream 212 of molten material 121, which can maintain a viscosity of the inner portion 232 of the second stream 212 of molten material 121 below the liquidus viscosity of the second stream 212 of molten material 121. In some embodiments, methods can further comprise adjusting a heating rate of the inner portion 232 of the second stream 212 of molten material 121 to facilitate maintenance of the thickness 227 of the glass ribbon 103 within the thickness range discussed above. In further embodiments, adjusting a heating rate of the inner portion 232 of the second stream 212 of molten material 121 can comprise adjusting the heating rate of the heater 241, 303 to facilitate maintenance of the thickness 227 of the glass ribbon 103 within the thickness range discussed above.

Methods can further comprise heating the first outer surface 223 of the first wall 213 and heating the second outer surface 224 of the second wall 214 where the first wall 213 and the second wall 214 converge in the draw direction 154 to form an integral junction comprising the root 145. In some embodiments, heating the first outer surface 223 of the first wall 213 and heating the second outer surface 224 of the second wall 214 can further comprise heating the root 145. In further embodiments, heating the root 145 can maintain a temperature of the root 145 above the liquidus temperature of the first stream 211 of molten material 121 and above the liquidus temperature of the second stream 212 of molten material 121. In even further embodiments, methods can comprise adjusting a heating rate of the root 145 to maintain a temperature of the root 145 above the liquidus temperature of the first stream 211 of molten material 121 and above the liquidus temperature of the second stream 212 of molten material 121. In some embodiments, the viscosity of the glass ribbon 103 where the first stream 211 of molten material 121 and the second stream 212 of molten material 121 are drawn can be about 8,000 poise or more, about 10,000 poise or more, about 15,000 poise or more, about 20,000 poise or more, about 35,000 poise or less, about 30,000 poise or less, about 25,000 poise or less, or about 20,000 poise or less. In some embodiments, the viscosity of the glass ribbon 103 where the first stream 211 of molten material 121 and the second stream 212 of molten material 121 converge can be in a range from about 8,000 poise to about 35,000 poise, from about 8,000 poise to about 30,000 poise, from about 8,000 poise to about 25,000 poise, from about 8,000 poise to about 20,000 poise, from about 10,000 poise to about 35,000 poise, from about 10,000 poise to about 30,000 poise, from about 10,000 poise to about 25,000 poise, from about 10,000 poise to about 20,000 poise, from about 15,000 poise to about 35,000 poise, from about 15,000 poise to about 30,000 poise, from about 15,000 poise to about 25,000 poise, or any range or subrange therebetween.

Methods can further comprise cooling an outer portion 221 of the first stream 211 of molten material 121 to increase the viscosity of the outer portion 221 of the first stream 211 of molten material 121 above the liquidus viscosity of the first stream 211 of molten material 121. In some embodiments, methods can further comprise adjusting a cooling rate of the outer portion 221 of the first stream 211 of molten material 121 to facilitate maintenance of the thickness 227 of the glass ribbon 103 within the thickness range discussed above.

Methods can further comprise cooling an outer portion 222 of the second stream 212 of molten material 121 to increase the viscosity of the outer portion 222 of the second stream 212 of molten material 121 above the liquidus viscosity of the second stream 212 of molten material 121. In some embodiments, methods can further comprise adjusting a cooling rate of the outer portion 222 of the second stream 212 of molten material 121 to facilitate maintenance of the thickness 227 of the glass ribbon 103 within the thickness range discussed above.

Methods can comprise heating the inner portion 231 of the first stream 211 of molten material 121 and/or heating the inner portion 232 of the second stream 212 of molten material 121 in combination with cooling the outer portion 221 of the first stream 211 of molten material 121 and/or cooling the outer portion 222 of the second stream 212 of molten material 121 to achieve technical benefits of embodiments of the disclosure. Methods can further comprise adjusting the heating rate of the inner portion 231 of the first stream 211 of molten material 121 and/or adjusting the heating rate of the inner portion 232 of the second stream 212 of molten material 121 in combination with adjusting the cooling rate of the outer portion 221 of the first stream 211 of molten material 121 and/or adjusting the cooling rate of the outer portion 222 of the second stream 212 of molten material 121 to achieve technical benefits of the embodiments of the disclosure. Additionally, the above heating, cooling, and adjustments thereof can be operating in combination with the pull rollers 173a, 173b located downstream from the edge rollers 171a, 171b to obtain a predetermined thickness (e.g., thickness 227) of the glass ribbon 103, which can be within the thickness range discussed above.

A technical benefit of the embodiments of the disclosure is that the predetermined thickness can be obtained with reduced incidence (e.g., without encountering) devitrification of the molten material 121 and/or baggy warp of the glass ribbon 103. Another technical benefit is that the predetermined thickness can be obtained with reduced incidence (e.g., without encountering) devitrification of the molten material 121 and/or baggy warp of the glass ribbon 103 molten materials with low liquidus viscosity (e.g., in a range from about 5,000 poise to about 30,000 poise, in a range from about 5,000 to about 20,000 poise).

Heating the first wall 213 to heat and/or adjust the heating rate of the inner portion 231 of the first stream 211 of molten material 121 maintain the viscosity of the inner portion 231 of the first stream 211 of molten material 121 can help reduce (e.g., eliminate) devitrification. Without wishing to be bound by theory, the portion of a stream of molten material that has the longest residence time on the forming vessel is the inner portion of the stream of molten material. Maintaining the viscosity of the inner portion 231 of the first stream 211 of molten material 121 above the liquidus viscosity of the first stream 211 of molten material 121 can reduce (e.g., prevent) devitrification since devitrification cannot occur in materials that are below their liquidus viscosity (e.g., above their liquidus temperature). Moreover, embodiments of the disclosure can provide the technical benefit of more efficient drawing (e.g., fusion drawing) of glass ribbons, for example, by minimizing a draw length for the glass ribbon to obtain its final thickness and/or begin rigid enough to be handled with rollers (e.g., pull rollers).

Heating the second wall 214 to heat and/or adjust the heating rate of the inner portion 232 of the second stream 212 of molten material 121 maintain the viscosity of the inner portion 232 of the second stream 212 of molten material 121 can help reduce (e.g., eliminate) devitrification. Maintaining the viscosity of the inner portion 232 of the second stream 212 of molten material 121 above the liquidus viscosity of the second stream 212 of molten material 121 can reduce (e.g., prevent) devitrification since devitrification cannot occur in materials that are below their liquidus viscosity (e.g., above their liquidus temperature).

The heater 241, 303 positioned in the cavity 220 at least partially defined by the first wall 213 and the second wall 214 both within the thickness ranges disclosed above can provide the additional technical benefit of localizing heating to a predetermined region of the inner portion 231 of the first stream 211 of molten material 121 and/or the inner portion 232 of the second stream 212 of molten material 121. The cavity 220 at least partially defined by the first wall 213 and second wall 214 provides thermal isolation of the heater 241, 303 from the upper portion of the forming device 140, 301 (e.g., the pipe 201, the support beam 157). Additionally, the first wall 213 and the second wall 214 being within the above thickness ranges minimizes the vertical spread of the heating from the heater 241, 303 as the heat is conducted through the first wall 213 and/or second wall 214, which allow for localized heating of a predetermined portion of the region of the inner portion of the stream(s) (e.g., inner portion 231 of the first stream 211, inner portion 232 of the second stream 212) of molten material 121. As heating is localized, heating can be confined to the inner portions 231, 232 of the streams 211, 212 of molten material to avoid overheating that may result in baggy warp while at the same time preventing devitrification of the streams of molten material at the inner portions 231, 232 of the streams 211, 212 of molten material.

Cooling the outer portion 221 of the first stream 211 of molten material 121 and/or adjusting the cooling rate of the outer portion 221 of the first stream 211 of molten material 121 can increase and/or maintain the viscosity of the outer portion 221 of the first stream 211 of molten material 121 above the liquidus viscosity of the first stream 211 of molten material 121. Without wishing to be bound by theory, a material cooled such that its viscosity is above its liquidus viscosity is unlikely to undergo devitrification within a short period of time thereafter. Without wishing to be bound by theory, aggressively cooling the outer portion of a stream of molten material can increase the effective (e.g., average) viscosity of the glass ribbon drawing from that stream. As such, cooling and/or adjusting the cooling rate of the outer portion 221 of the first stream 211 of molten material 121 can increase the effective viscosity of the glass ribbon 103 drawn from the root 145, which can decrease (e.g., eliminate) baggy warp. Further, such cooling facilitates greater pulling forces from the pull rollers 173a, 173b without encountering baggy warp. Moreover, a glass ribbon 103 with a higher viscosity when it is drawn from the root 145 can be handled using rollers (e.g., pull rollers 173a, 173b) after a shorter distance in the draw direction 154 and/or more quickly as compared to a glass ribbon with a lower viscosity when it is drawn.

Cooling the outer portion 222 of the second stream 212 of molten material 121 and/or adjusting the cooling rate of the outer portion 222 of the second stream 212 of molten material 121 can increase and/or maintain the viscosity of the outer portion 222 of the second stream 212 of molten material 121 above the liquidus viscosity of the second stream 212 of molten material 121. As discussed above with regards to the first stream 211, cooling and/or adjusting the cooling rate of the outer portion 222 of the second stream 212 of molten material 121 can increase the effective viscosity of the glass ribbon 103 drawn from the root 145, which can decrease (e.g., eliminate) baggy warp. Further, such cooling facilitates greater pulling forces from the pull rollers 173a, 173b without encountering baggy warp. Moreover, a glass ribbon 103 with a higher viscosity when it is drawn from the root 145 can be handled using rollers (e.g., pull rollers 173a, 173b) after a shorter distance in the draw direction 154 and/or more quickly as compared to a glass ribbon with a lower viscosity when it is drawn.

It will be appreciated that the various disclosed embodiments may involve particular features, elements, or steps that are described in connection with that particular embodiment. It will also be appreciated that a particular feature, element, or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises embodiments having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C. As used herein, the terms “comprising” and “including”, and variations thereof shall be construed as synonymous and open-ended unless otherwise indicated.

It will be apparent to those skilled in the art that various modifications and variations can be made to the present disclosure without departing from the spirit and scope of the appended claims. Thus, it is intended that the present disclosure cover the modifications and variations of the embodiments herein provided they come within the scope of the appended claims and their equivalents.

1. A forming device for forming a glass ribbon comprising:
a first wall comprising a first outer surface, a first inner surface, and a first thickness defined between the first outer surface and the first inner surface in a range from about 0.5 millimeters to about 10 millimeters;
a second wall comprising a second outer surface, a second inner surface, and a second thickness defined between the second outer surface and the second inner surface in a range from about 0.5 millimeters to about 10 millimeters;
an integral junction at a convergence of the first outer surface and the second outer surface, the integral junction comprising a root of the forming device; and
a heater positioned in a cavity at least partially defined by the first inner surface and the second inner surface.

2. The forming device of claim 1, wherein the heater is supported by the first wall and the second wall.

3. The forming device of claim 1, further comprising an electrically insulating material at least partially circumscribing the heater.

4. The forming device of claim 3, wherein the electrically insulating material contacts the inner surface of the first wall and the inner surface of the second wall.

5. The forming device of claim 1, wherein the first wall comprises an electrically conductive material and the second wall comprises an electrically conductive material.

6. The forming device of claim 5, wherein the electrically conductive material of the first wall comprises platinum or a platinum alloy and the electrically conductive material of the second wall comprises platinum or a platinum alloy.

7. The forming device of claim 1, further comprising a pipe comprising a pipe wall at least partially circumscribing a flow passage and a slot extending through the pipe wall, an upstream end of the first wall attached at a first peripheral location of an outer surface of the pipe wall, and an upstream end of the second wall attached at a second peripheral location of the outer surface of the pipe wall, wherein the slot is circumferentially located between the first peripheral location and the second peripheral location.

8. The forming device of claim 7, wherein the pipe comprises platinum or a platinum alloy.

9. The forming device of claim 7, further comprising a support beam supporting the pipe, the support beam comprising a segment positioned in the cavity between the pipe and the heater.

10. The forming device of claim 1, further comprising a first cooling device facing the first outer surface and a second cooling device facing the second outer surface.

11. A method of forming a glass ribbon with the forming device of claim 1 comprising:
flowing a first stream of molten material over the first outer surface of the first wall and flowing a second stream of molten material over the second outer surface of the second wall, the first stream of molten material and the second stream of molten material converging at the root to form a glass ribbon, wherein a liquidus viscosity of the first stream of molten material and a liquidus viscosity of the second stream of molten material are each in a range from about 5,000 poise to about 30,000 poise;
heating the first wall with the heater to heat an inner portion of the first stream of molten material contacting the first outer surface of the first wall to maintain a viscosity of the inner portion of the first stream of molten material below the liquidus viscosity of the first stream of molten material, and heating the second wall with the heater to heat an inner portion of the second stream of molten material contacting the second outer surface of the second wall to maintain a viscosity of the inner portion of the second stream of molten material below the liquidus viscosity of the second stream of molten material; and
drawing the glass ribbon from the root, the glass ribbon comprising a thickness in a thickness range from about 100 micrometers to about 2 millimeters.

12. The method of claim 11, further comprising adjusting a heating rate of the root to maintain a temperature of the root above a liquidus temperature of the first stream of molten material and above a liquidus temperature of the second stream of molten material.

13. A method of forming a glass ribbon comprising:
flowing a first stream of molten material over a first outer surface of a first wall and flowing a second stream of molten material over a second outer surface of a second wall, the first stream of molten material and the second stream of molten material converging to form a glass ribbon, wherein a liquidus viscosity of the first stream of molten material and a liquidus viscosity of the second stream of molten material are each in a range from about 5,000 poise to about 30,000 poise;
heating the first wall to heat an inner portion of the first stream of molten material contacting the first outer surface of the first wall to maintain a viscosity of the inner portion of the first stream of molten material below the liquidus viscosity of the first stream of molten material, and heating the second wall to heat an inner portion of the second stream of molten material contacting the second outer surface of the second wall to maintain a viscosity of the inner portion of the second stream of molten material below the liquidus viscosity of the second stream of molten material; and
drawing the glass ribbon comprising a thickness in a thickness range from about 100 micrometers to about 2 millimeters.

14. The method of claim 13, wherein an integral junction at a convergence of the first outer surface and the second outer surface comprises a root and the method further comprises adjusting a heating rate of the root to maintain a temperature of the root above a liquidus temperature of the first stream of molten material and above a liquidus temperature of the second stream of molten material.

15. The method of claim 13, wherein the liquidus viscosity of the first stream of molten material and the liquidus viscosity of the second stream of molten material is in a range from about 5,000 poise to about 20,000 poise.

16. The method of claim 13, wherein the thickness range is from about 100 micrometers to about 1.5 millimeters.

17. The method of claim 13, wherein a viscosity of the glass ribbon where the first stream of molten material and the second stream of molten material converge is in a range from about 8,000 poise to about 35,000 poise.

18. The method of claim 13, further comprising:
cooling an outer portion of the first stream of molten material opposite the inner portion of the first stream of molten material to increase a viscosity of the outer portion of the first stream of molten material above the liquidus viscosity of the first stream of molten material; and
cooling an outer portion of the second stream of molten material opposite the inner portion of the second stream of molten material to increase a viscosity of the outer portion of the second stream of molten material above the liquidus viscosity of the second stream of molten material.

19. The method of claim 18, further comprising adjusting a cooling rate of the outer portion of the first stream of molten material to facilitate maintenance of the thickness of the glass ribbon within the thickness range.

20. The method of claim 18, further comprising adjusting a heating rate of the inner portion of the first stream of molten material to facilitate maintenance of the thickness of the glass ribbon within the thickness range.

21. The method of claim 18, further comprising adjusting a cooling rate of the outer portion of the second stream of molten material to facilitate maintenance of the thickness of the glass ribbon within the thickness range.

22. The method of claim 18, further comprising adjusting a heating rate of the inner portion of the second stream of molten material to facilitate maintenance of the thickness of the glass ribbon within the thickness range.
